(19) United States
(12) Patent Application Publication
(10) Pub. No.: US 2011/0179157 A1
(43) Pub. Date: Jul. 21, 2011

(54) Event Management System For Creating A Second Event

(76) Inventors: Ted Beers, Corvallis, OR (US); Jon A. Brewster, Corvallis, OR (US); Michael D. Derocher, Albany, OR (US); Mark E. Gorzynski, Corvallis, OR (US); Lonnie D. Mandigo, Corvallis, OR (US); April S. Mitchell, San Jose, CA (US); Kenton O'hara, Bristol (GB)

(21) Appl. No.: 13/120,008

(22) PCT Filed: Sep. 26, 2008
(86) PCT No.: PCT/US2008/077898

§ 371 Date: Mar. 21, 2011

(51) Int. Cl. G06F 15/173

(52) U.S. Cl. 709/223

(57) ABSTRACT

An event management system is configured to host a first event that includes a first set of event endpoints that provides first and second sets of media streams to respective first and second sets of attendees during the first event. The event management system is configured to, while hosting the first event, create a second event that includes a second set of event endpoints that provide a third set of media streams to at least one of the first set of attendees and a fourth set of media streams during the second event. At least one of the second set of event endpoints is sufficiently separated from each of the first set of event endpoints so that the second event does not substantially interfere with the first event.

### BACKGROUND

Collaboration event systems allow for collaboration between people in different locations. These systems allow participants to interact with one another through the use of audio and video equipment that provides real time audio and video communications. The process of connecting people across various locations may become complex, particularly where different groups of people desire to use part of the same collaboration event system for different collaborations.

During a collaboration event, situations may arise where a subset of people participating in the event may desire to collaborate separately from the remaining people in of the event. If two different subsets of people try to carry on separate collaborations in a collaboration event across multiple locations, the collaboration event may become confusing or difficult to follow for some or all of the participants.

### BRIEF DESCRIPTION OF THE DRAWINGS

FIG. 1 is a block diagram illustrating one embodiment of a collaboration event system.

FIGS. 2A-2B are block diagrams illustrating embodiments of an event endpoint.

FIGS. 3A-3B are block diagrams illustrating embodiments of configurations of audio/video devices.

FIG. 4 is a flow chart illustrating an embodiment of a method performed by an event management system.

FIG. 5 is a block diagram illustrating an embodiment of event endpoint locations.

FIGS. 6A-6C is are block diagrams illustrating embodiments of events.

FIGS. 7A-7C is are block diagrams illustrating embodiments of events.

### DETAILED DESCRIPTION

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense.

As described herein, an event management system manages collaboration events such as video teleconferences. The event management system maintains registered event specifications for each collaboration event and dynamic event context information that describes the status of collaboration events relative to each other. The event management system uses the registered event specifications and the dynamic event context information to optimize the interaction between collaboration events. The event management system also includes event endpoint information and policies that describe relationships among endpoints and rules associated with endpoints and event attendees.

The event management system is configured to allow one or more attendees from a first collaboration event to create and participate in a second collaboration event, separate from the first event, while the first event continues. The event management system maintains an association between the first and second events to allow attendees and endpoints to readily move between the events. The second event includes one or more additional endpoints and allows attendees of the second event to collaborate without interfering with the first event. During the second event, the first collaboration event may continue unmodified (except for the absence of the attendees in the second collaboration event) or may be modified to cause an endpoint to be moved from the first event to the second event. After the second event, the attendees may rejoin the first event by returning to an endpoint of the first event or causing an additional endpoint (e.g., an endpoint from the second event) to be added to the first event. The event management system may restore the nature of the participation of attendees in the first event according to registered event specifications and/or dynamic event context. By doing so, the event management system may allow endpoints to rejoin the first event in the same topology position without protracted request negotiation that may precede new endpoints joining the first event.

In one embodiment, the event management system allows the second event to form a virtual hallway conversation between at least two attendees in at least two different locations. The attendees each either move from an endpoint of the first event to another nearby endpoint or cause an endpoint of the first event to be moved from the first event to the second event. The attendees of the second event may return to the first event subsequent to completing the virtual hallway conversation. Accordingly, the attendees of the second event may temporarily collaborate separately from the attendees of the first event to carry out the virtual hallway conversation during the second event.

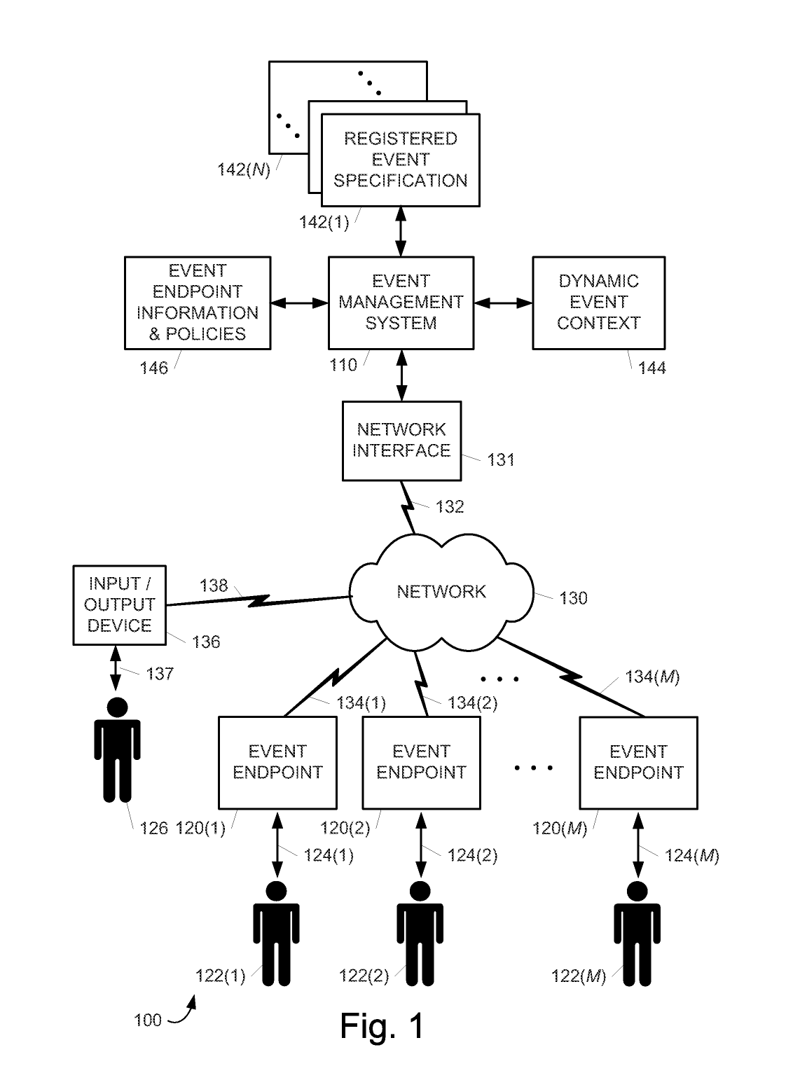

FIG. 1 is a block diagram illustrating one embodiment of a collaboration event system 100. Collaboration event system 100 includes an event management system 110, a set of event endpoints 120(1)-120(M), and a network 130 that interconnects event management system 110 and event endpoints 120.

Collaboration event system 100 is configured to create and host collaboration events. A collaboration event is an activity with experiential relevance to people, possessing an extension in time and location. Examples of a collaboration event (hereafter “event”) include telepresence videoconferences and meetings conducted using collaboration studio such as a “Halo studio” offered by Hewlett-Packard Co. For each event, collaboration event system 100 exchanges a selected set of audio and/or video (A/V) media streams 124(1)-124(M) between a selected set or subset of event endpoints 120(1)-120(M).

An event includes a set of collaboration system topologies, each of which include a set or subset of event endpoints 120(1)-120(M). An event also includes a registered event specification 142 that specifies information such as a unique identity token, a purpose, a list of event attendees, a list of event resources, contact information of a host of the event, a priority of the event, start and end dates and times, and/or an event duration. Event resources may include event endpoints 120 including interactive touchpoints at event endpoints 120, physical locations (e.g., a collaboration studio or conference room), and attendees 122.

The collaborative event may take place in two or more locations (e.g., different cities) that each have an event endpoint 120 to connect a set of one or more attendees 122 or media resources in each of the locations. Cameras and microphones, for example, may capture video and audio from one or more of the locations (i.e., at one endpoint) and the video and audio may be output using one or more display devices and speakers, for example, at one or more other locations (i.e., one or more other endpoints). In addition, various types of pre-recorded A/V data, such as content from a DVD, may be transported to one or more of the locations where it may be output using a display device or speakers, for example. One or more locations of the collaborative event may include arrangements of office furniture (e.g., office chairs and a conference table) and A/V gear to provide persons with gaze awareness and a full immersive feeling.

Event management system 110 is configured to initiate, execute, host, and optimize collaboration events using registered event specifications 142(1)-142(N), dynamic event context 144, and event endpoint information and policies 146. Each event is registered with event management system 110, either in advance (i.e., scheduled ahead of time) or in real time (i.e., scheduled on an ad hoc basis), to create a registered event specification 142 for the event using any suitable device for accessing event management system 110 (e.g., an event endpoint 120 or an input/output device connected to event management system 110 (not shown)). Event management system 110 may reference and use each registered event specification 142 for various purposes including preparation for and execution of an event in accordance with the information in a registered event specification 142.

Dynamic event context 144 is real-time information that describes the status of events (e.g., in-progress, interrupted, extended, etc.), the status of events relative to each other (e.g., overlapping or not overlapping based on the start and end times of events), the status of event endpoints 120 and other media resources (e.g., available, reserved, in use or otherwise occupied, or unavailable), and the status of attendees 122 (e.g., checked-in at an event endpoint 120 or elsewhere or not checked-in along with any special privilege indicators or other attendee designations) for each event. Event management system 110 generates and maintains dynamic event context 144 to monitor and manage the real-time system status of collaboration event system 100.

Endpoint information and policies 146 describes the locations, topologies, configurations, and operation policies of event endpoints 120(1)-120(M). Event management system 110 accesses event endpoint information and policies 146 for use in configuring and optimizing collaboration events. Event management system 110 may also reference and use other system information such as the time of day in the process of managing collaboration events.

Each event endpoint 120(1)-120(M) provides a respective set of one or more attendees 122(1)-122(M) with a respective set of one or more audio and/or visual media streams 124(1)-124(M) using network 130. Each event endpoint 120 includes any suitable type, number, and combination of audio and/or visual input and/or output devices that are configured to generate, provide, and/or receive the respective set of media streams 124. Media streams 124 may each be any suitable combination of live or pre-recorded audio and/or video data and/or collaborative data such as XML data that may be combined in any suitable way and output to any number of attendees 122 in any number of event endpoints 120 by collaboration event system 100. Each set of attendees 122(1)-122(M) includes one or more people where the number of people may stay the same, increase, or decrease during the course of an event. In addition, the set of event endpoints 120 for an event may stay the same, increase, or decrease during the course of an event.

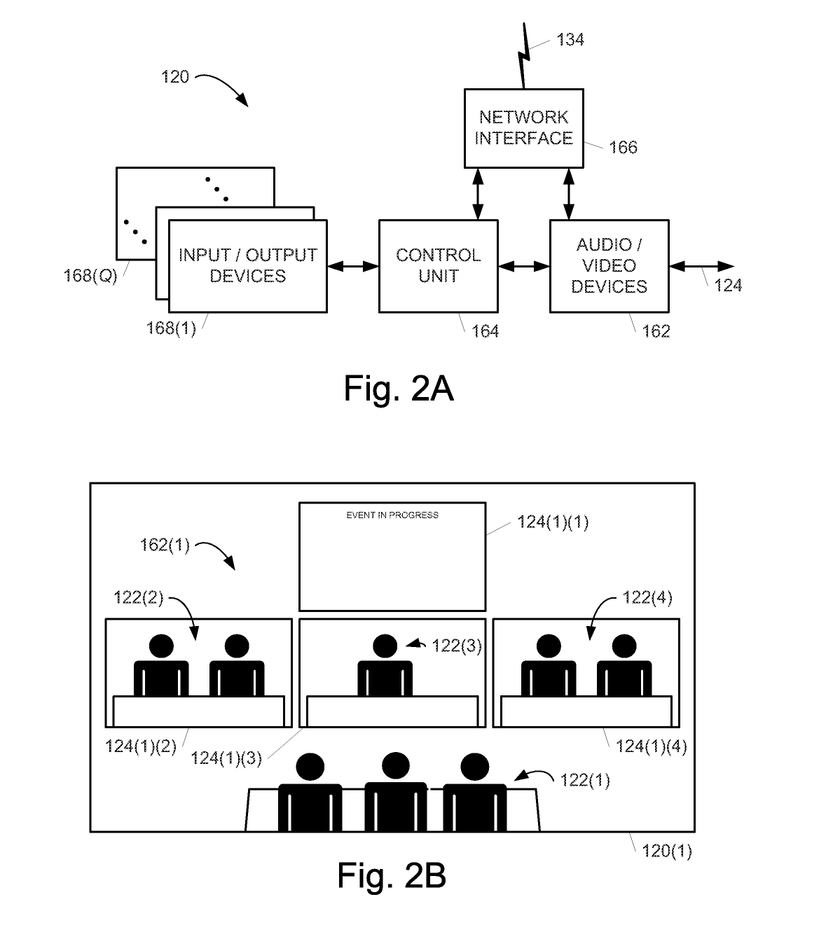

FIGS. 2A-2B are block diagrams illustrating embodiments of event endpoint 120. In the embodiment of FIG. 2A, event endpoint 120 includes a set of one or more audio and/or video (A/V) devices 162, a control unit 164, a network interface 166 and a set of one or more input/output (I/O) devices 168(1)-168(Q).

A/V devices 162 includes any type, number, and combination of audio and/or video input and/or output devices. Examples of A/V input devices include microphones, still and video cameras, media players, and computer and storage systems. The A/V input devices capture, detect, receive or otherwise input live or pre-recorded media streams 124 and provide the input media streams 124 to control unit 164 and/or network interface 166. Examples of A/V output devices include speakers, headphones, headsets, media recorders, and display devices such as projectors, computer monitors, and televisions. The A/V output devices receive media streams from control unit 164 and/or network interface 166 and provide, display, play, or otherwise output live or pre-recorded media streams 124.

Control unit 164 manages the operation of event endpoint 120 by providing control signals and/or other information to and receiving control signals and/or other information from A/V devices 162, network interface 166 and input/output devices 168(1)-168(Q). In some embodiments, control unit 164 may perform processing on media streams received from A/V devices 162 and/or network interface 166 prior to the media streams being provided to network interface 166 or output by A/V devices 162. The processing may include coding or decoding media streams from one media and/or network format to another media and/or network format.

Network interface 166 includes any suitable type, number, and/or combination of network devices that allow event endpoint 120 to communicate with network 130 using network connection 134. Network interface 166 receives media streams across network connection 134 and provides the media streams to control unit 164 and/or A/V devices 162. Network interface 166 also receives media streams from control unit 164 and/or A/V devices 162 and provides the media streams to network 130 using network connection 134.

I/O devices 168(1)-168(Q) include any suitable type, number, and or combination of input and/or output devices that allow attendees 122, administrators, or other persons to communicate with event endpoint 120. The communications may cause event endpoint 120 and/or collaboration event system 100 to perform functions indicated by attendees 122, administrators, or other persons. Examples of I/O devices 168 include interactive touchpoints, display screens, keyboards, and selection or navigation devices (e.g., a mouse, joystick, flywheel, or touchpad).

In other embodiments, the functionality of an NV device 162 and an I/O device 168 may be included in a single unit such as a laptop computer. In addition, other embodiments may include A/V devices 162 but omit I/O devices 168 or may include I/O devices 168 but omit NV devices 162.

FIG. 2B illustrates an embodiment of the operation of endpoint 120(1). Endpoint 120(1) provides attendees 122(1) who are present at endpoint 120(1) with media streams 124(1)(1)-124(1)(4) using any suitable type and/or combination of audio/video devices 162(1). Audio/video devices 162(1) are configured to allow for gaze awareness and a full immersion feeling for attendees 120(1).

In the example of FIG. 2B, media stream 124(1)(1) provides information about the event attended by attendees 122(1) (e.g., status information, notifications, configuration options, etc.) and media streams 124(1)(2)-124(1)(4) provide audio and video representations of by attendees 122(2)-122(4), respectively, who are present at event endpoints 120(2)-120(4), respectively. Attendees 122(1)-122(4) collectively represent the set of attendees who are present for the event illustrated by the example of FIG. 2B. In other embodiments, endpoint 120(1) may provide other numbers of media streams 124(1) to attendees 120(1) and may have other configurations of audio video devices 162(1) relative to attendees 120(1).

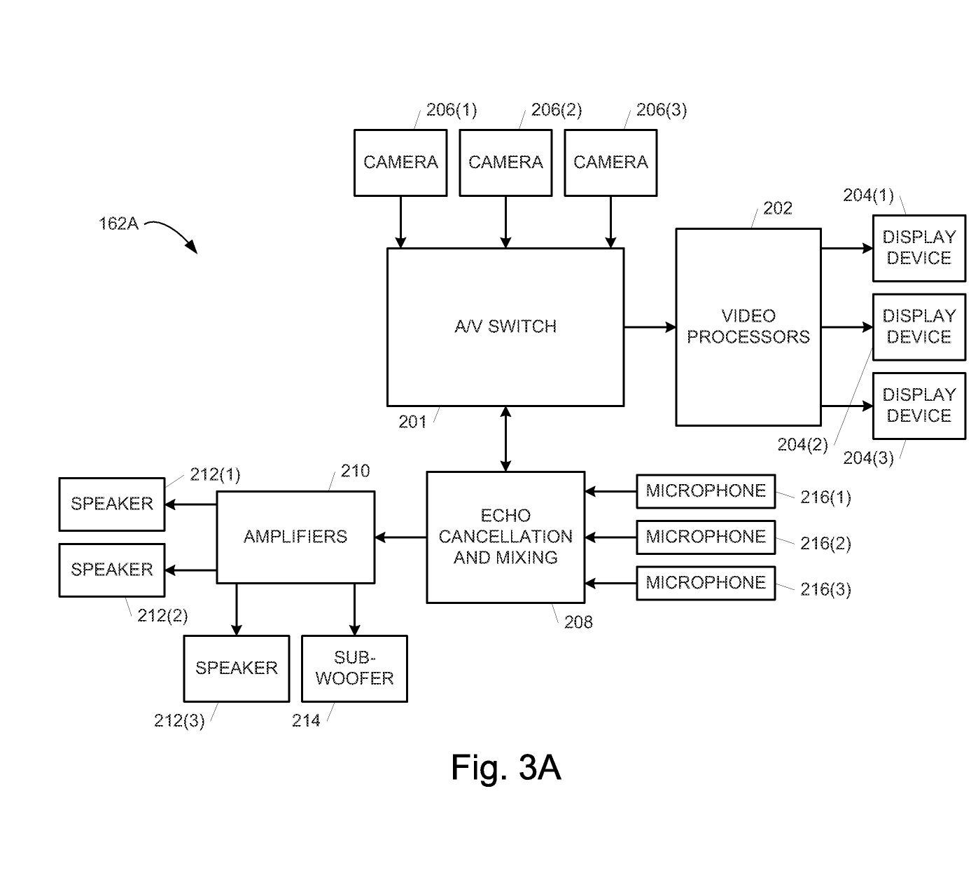

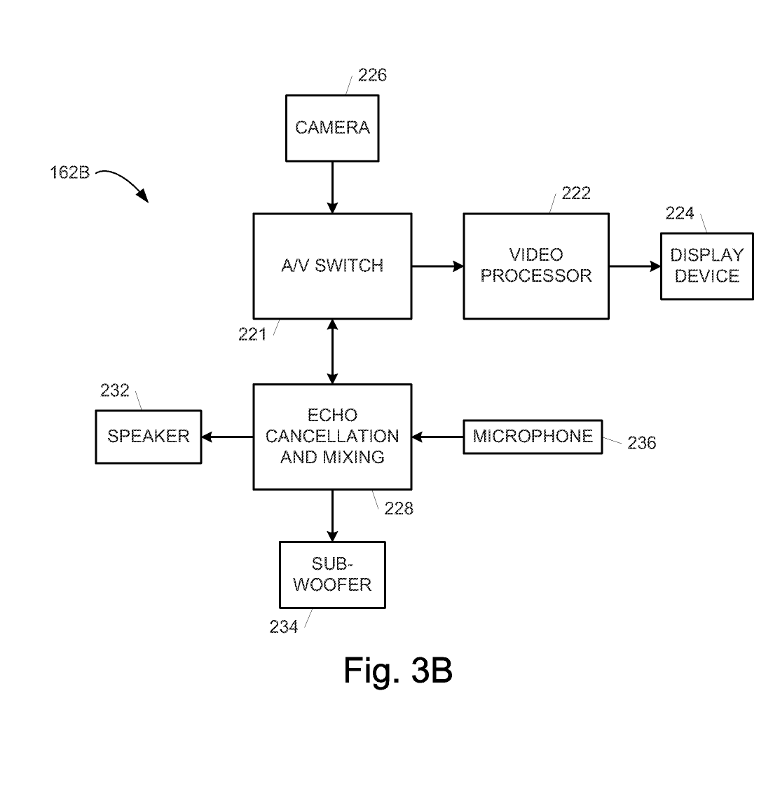

FIGS. 3A-3B are block diagrams illustrating embodiments of configurations of audio/video devices 162.

In one embodiment, A/V devices 162 includes integrated A/V gear that forms a collaboration studio such as a “Halo studio” offered by Hewlett-Packard Co. as shown in the embodiment 162A of FIG. 3A. In the embodiment of FIG. 3A, video processors 202 provide video data from A/V switch 201 to display devices 204(1)-204(3), and display devices 204(1)-204(3) display the video data. Cameras 206(1)-206(3) capture video data and provide the video data to A/V switch 201. An echo cancellation and mixing unit 208 mixes and processes audio data from A/V switch 201 and provides the processed audio data to amplifiers 210. Amplifiers 210 amplify the audio data and provide the audio data to speakers 212(1)-212(3) and sub-woofer 214. Speakers 212(1)-212(3) output the higher frequencies of the audio data, and sub-woofer 214 outputs the lower, bass frequencies of the audio data. Microphones 216(1)-216(3) capture audio data and provide the audio data to A/V switch 201.

Display devices 204(1)-204(3) may be arranged in such a manner around a conference table and chairs to allow for gaze awareness and a full immersion feeling in one embodiment.

In another embodiment, A/V devices 162 includes NV gear as shown in the embodiment 162B of FIG. 3B. In the embodiment of FIG. 3B, video processor 222 provides video data from A/V switch 221 to display device 224, and display device 224 displays the video data. Camera 226 captures video data and provides the video data to NV switch 221. An echo cancellation and mixing unit 228 mixes and processes audio data from A/V switch 221 and provides the processed audio data to speaker 232 and sub-woofer 234. Speaker 232 outputs the higher frequencies of the audio data, and sub-woofer 234 outputs the lower, bass frequencies of the audio data. Microphone 236 captures audio data and provides the audio data to NV switch 221 through echo cancellation and mixing unit 228.

Referring back to FIG. 1, network 130 may be any suitable type of network or combination of networks formed from any suitable number, type, and/or combination of network devices (not shown). The network devices may operate using any suitable network protocol or protocols and may connect to any suitable number of event endpoints 120 or other computer or storage systems. Network 130 may include any suitable combination of secure networks (e.g., enterprise networks or corporate intranets) with limited and secure connections to other systems or unsecure networks with at least one unsecure connection to another system.

Network 130 may be a local, regional, or global network of any suitable network configuration that ranges from local point-to-point connections between event management system 110 and event endpoints 120 to a global array of connections that interconnect event management system 110 and event endpoints 120. Network 130 may be private or publicly available and include one or more connections to the Internet.

Network 130 may be designed specifically to optimize high bandwidth with low latency to be able to transport live, interactive, audio, video, and other data rich media streams. Network 130 may have a smallest link of 45 Mbps, in one embodiment, to avoid any significant serialization delay. Network 130 may also use a flat network topology to minimize latency. In order to keep a high quality end-user experience, network 130 may keep the total one-way latency between any event endpoints 120 to less than one-quarter of a second. This total latency may encompass all aspects of encoding/decoding, encapsulation/de-encapsulation, capture and presentation, filtering, processing, compression and decompression, image compositing, and transport latencies across the transmission path. As the contribution of each component of network 130 to overall latency decreases (as technology improves), the length of the “reach” of where different sites can be physically located may be increased.

To better preserve the shortest paths capable of reliable delivery with little packet loss, bandwidth and network resource mechanisms (not shown) may be used to insure high-quality sessions for the duration of the collaboration session. As most traffic streams are presumed to take place linking a pair or small number of event endpoints 120 together for any given session, event management system 110 may have little presumption of event pre-emption once authorized events commence. In some embodiments, longer latency and/or loss tolerant sessions may be provided over network 130. Such services may include directory, presence, messaging, credential verification, calibration, and time/name services for examples.

The interior of network 130 may concentrate on speedy delivery of traffic flows. Any access control, encryption/decryption and other proxy services, if needed, may occur at the edge of network 130 such as in event endpoints 120 and not the interior of network 130 in some embodiments. This design may make the core of the backbone of network 130 simpler to grow, maintain, stabilize, and attain the desired latency.

Event management system 110 connects to network 130 using a network interface 131 and a network connection 132, and event endpoints 120(1)-120(M) connect to network 130 using respective network connections 134(1)-134(M). Each network connection 132 and 134(1)-134(M) may include any suitable type, number, and/or combination of wired or wireless network connections. For example, network connections 132 and 134(1)-134(M) may each be a leased line (i.e., a T3, optical, cable, or wireless high speed link) which provides a large data pipe to and from event management system 110 and event endpoints 120(1)-120(M), respectively.

Input/output (I/O) device 136 may be any suitable type of device (e.g., a portable or non-portable device such as an interactive touchpoint, a computer, a cell phone, a media player, or a personal digital assistant) configured to communicate with event management system 110 and thereby form an event management client. I/O device 136 is configured to receive inputs from a person 126 and/or provide outputs to person 126 as indicated by an arrow 137. The input and outputs may include audio and/or video inputs and outputs. I/O device 136 connects to network 130 using any suitable wired or wireless network connection 138. I/O device 136 may be omitted in some embodiments.

Person 126 may be associated with an event in various ways. For example, person 126 may be an organizer or registered attendee of an event who is identified by registered event specification 142 for the event. Person 126 may also be someone acting on behalf of an organizer or registered attendee identified by registered event specification 142 for the event. Person 126 may further be attempting to register for the event by adding his or her name to registered event specification 142 for the event. In addition, person 126 may be located at or near an event endpoint 120 for the scheduled event.

In operation, event management system 110 initiates, executes, hosts, and optimizes collaboration events using registered event specifications 142(1)-142(N), dynamic event context 144, and event endpoint information and policies 146.

Event management system 110 initiates execution of an event by allocating resources for creating a rear-time representation of the event according to the registered event specification 142 of the event to optimize the experience of attendees 122. The allocated resources include the set or a subset of event endpoints 120 as indicated by the registered event specification 142. Event management system 110 continues execution of the event with changes to the topology of the event (e.g., the addition or removal of event endpoints 120 during the event) to maintain and optimize the experience of attendees 122 and ends as dictated by the registered event specification 142 or by external inputs (e.g., from an attendee 122). During execution, event management system 110 may describe an event as being “in-progress”.

In preparation for event execution (i.e., during event preparation) and during event execution, certain activities may be performed by event resources or event management system 110 that impact the management of the event, such as an attendee 122 checking in at an endpoint location, an input/output device associated with an endpoint, or another location. During the course of the lifecycle of an event, additional related artifacts may be added to the event, such as an archive of the execution of the event.

Event management system 110 optimizes event preparation and event execution for each registered event that requires various resources including those resources whose states may impact event preparation and execution. The optimization accounts for resources that may be in use by one or more in-progress events, resources that may be unavailable (e.g., requested for use by another event or out of service), key event attendees 122 that are missing, and other critical event information. Event management system 110 also optimizes event execution for in-progress events by preventing unwanted disruption of an event using resources required by the registered event and by handling requests for resources made by other events.

Event management system 110 performs the optimization using registered event specifications 142 for all related events including the primary event being prepared and other events in progress that are consuming needed resources and dynamic event context information 144 which includes information about event resources (e.g., resources used by other in-progress events and other status information about needed resources). Event management system 110 may also perform the optimization using information provided by attendees, administrators, and or other persons via I/O devices 168 and/or 136 associated with the event in progress and the registered events and event endpoint information and policies 146. Event endpoint information and policies 146 includes information about the physical and assigned relationships among resources, including relationship information about event endpoints 120 and I/O devices 168 and/or 136, policies regarding the management of shared resources to facilitate optimal event execution, and principles governing the systems behaviors in consideration of the multitude of registered and dynamic information.

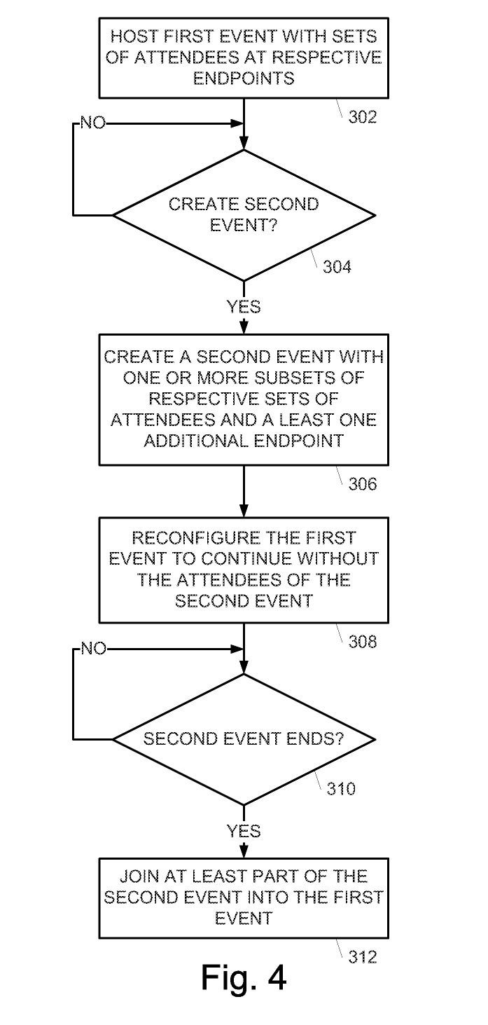

As noted above, the event management system is configured to allow one or more attendees from a first collaboration event to create and participate in a second collaboration event, separate from the first event, while the first event continues as will now be described in additional detail with reference to FIGS. 4-7C. The event management system maintains an association between the first and second events to allow attendees to readily move between the events. The second event may form a virtual hallway conversation that allows attendees of the second event to collaborate separately from, but in parallel with, the remaining attendees of the first event.

FIG. 4 is a flow chart illustrating an embodiment of a method performed by event management system 110 to allow one or more attendees from a first collaboration event to create and participate in a second collaboration event, separate from the first event, while the first event continues. In FIG. 4, event management system 110 hosts a first event with sets of attendees 122 at respective endpoints 120 as indicated in a block 302. Event management system 110 is configured to cause the first event to include two or more event endpoints 120 that provide respective sets of A/V media streams 124 to respective sets of attendees 122 during the first event.

A determination is made by event management system 110 as to whether a request to create a second event has been received as indicated in a block 304. At any point during the first event, an attendee 122 may provide a request to create a second event to event management system 110. The attendee 122 may provide the request using an I/O device 168 at an endpoint 120 of the first event, an I/O device 168 at an endpoint 120 located near one of endpoints 120 of the first event, or an I/O device 136 (e.g., an event management client) to provide the request to event management system 110. Event management system 110 receives the request to create the second event from the attendee 122 across network interface 131.

In response to receiving the request, event management system 110 creates a second event with one or more subsets of respective sets of attendees 122 and at least one additional endpoint as indicated in a block 306. Event management system 110 is configured to, while hosting the first event, create the second event. Event management system 110 may initialize the second event with no event endpoints 120 and provide communications to all or selected subsets of the sets of attendees 122 of the first event to notify some or all of the sets of attendees 122 of the initiation of the second event. Event management system 110 may provide all or selected subsets of the sets of attendees 122 of the first event with an option to join the second event. Event management system 110 may receive communications from one or more subsets of the sets of attendees 122 that indicate that the subsets of the sets of attendees 122 wish to join the second event. In response to the communications, event management system 110 may move each subset of the sets of attendees 122 that joins the second event into the second event by moving an endpoint 120 from the first event to the second event and/or directing the subset of the set of attendees 122 to a new endpoint 120 of the second event. Event management system 110 may provide an attendee 122 of the second event with the ability to invite additional attendees (i.e., attendees not from the first event) at additional endpoints 120. Each endpoint 120 added to the second event provides a respective set of A/V media streams 124 to a respective subset of attendees 122 or additional attendees invited to join the second event during the second event. Each subset includes one or more of a respective set of attendees 122 and may include all of the set of attendees 122.

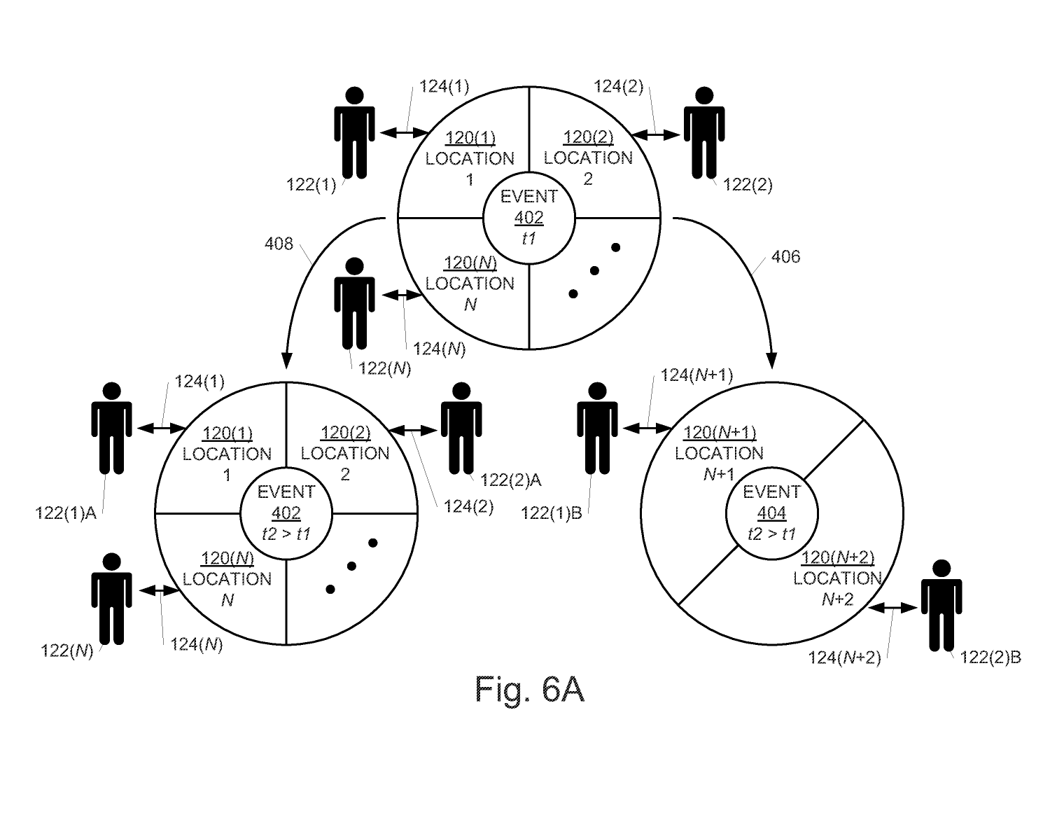

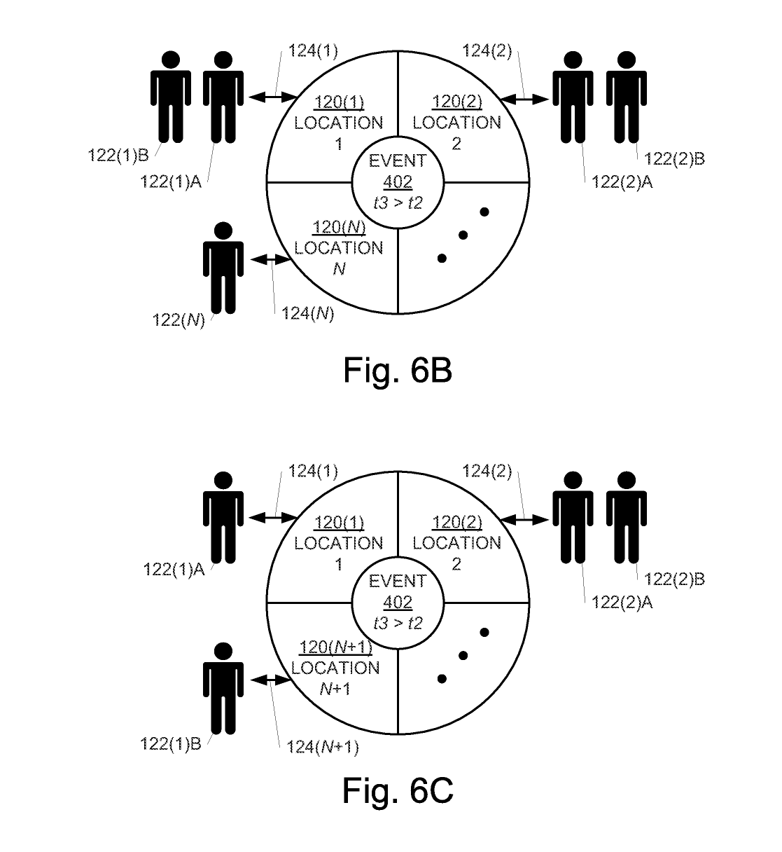

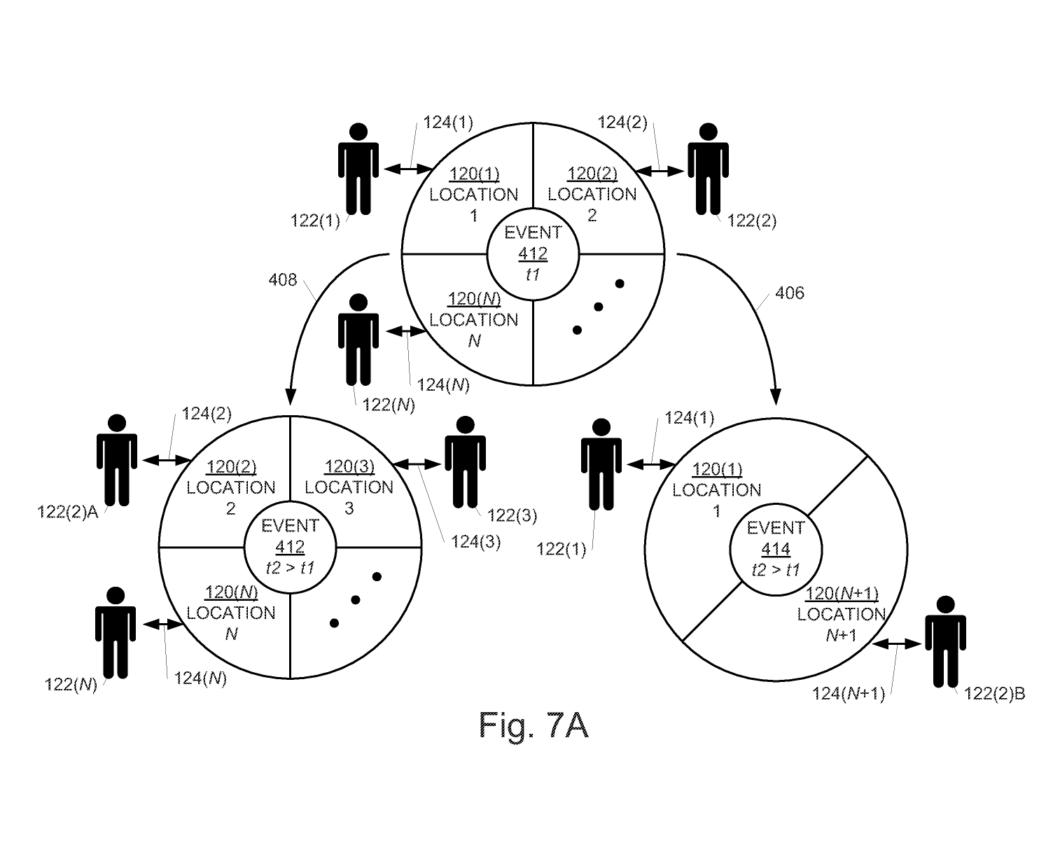

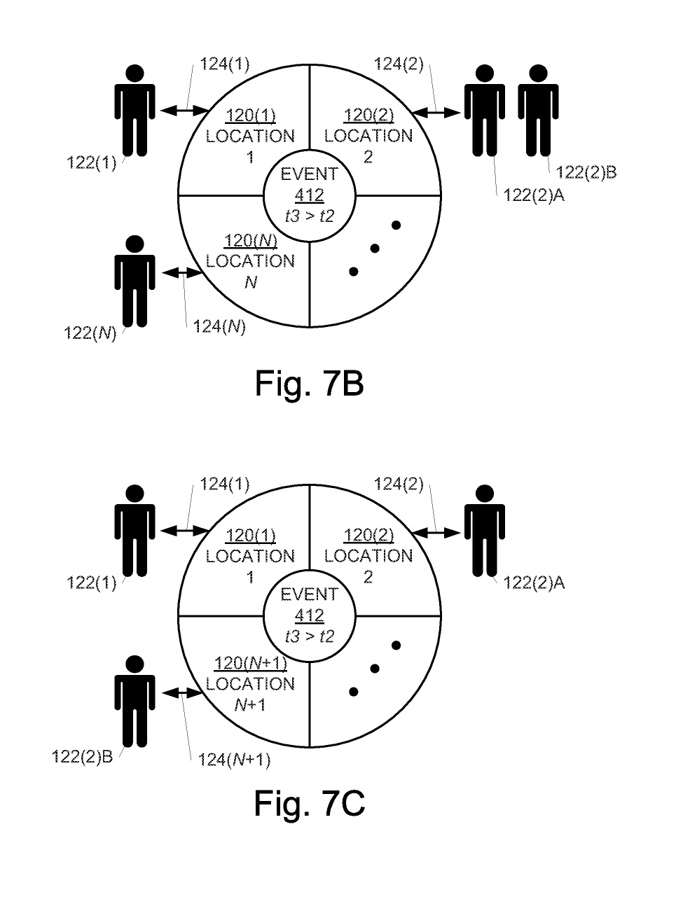

In one embodiment, event management system 110 creates the second event to include two or more additional endpoints 120 as described in additional detail with reference to FIGS. 6A-6C below. Event management system 110 may also create the second event to include one or more endpoints 120 moved from the first event to the second event in this embodiment. In another embodiment, event management system 110 creates the second event to include one additional endpoint 120 and at least one endpoint 120 from the first event as described in additional detail with reference to FIGS. 7A-7C below.

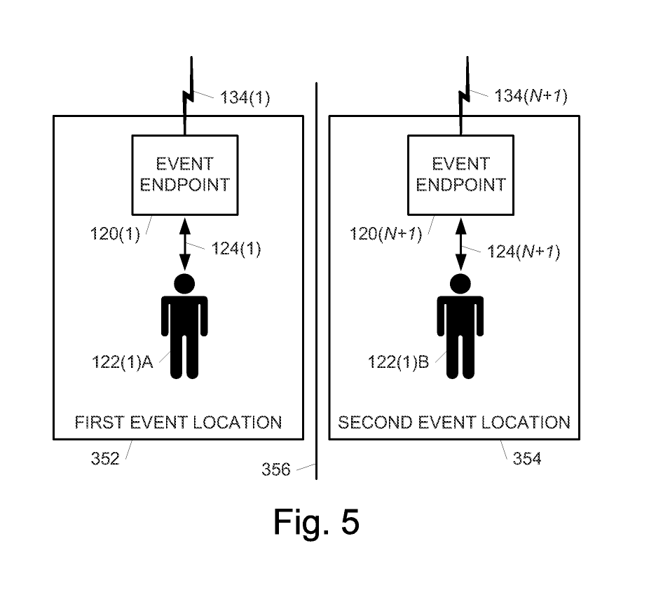

In the creation of the second event, at least one of the subsets of a set of attendees 122 moves from an endpoint 120 of the first event to a new endpoint 120 of the second event as illustrated in FIG. 5. FIG. 5 is a block diagram illustrating an embodiment of a first event endpoint location 352 and a second event endpoint location 354 that is near location 352. In the example of FIG. 5, the first event includes endpoints 120(1)-120(N), where N is an integer greater than or equal to two, (endpoints 120(2)-120(N) are not shown in FIG. 5) and the second event includes at least endpoint 120(N+1). Endpoint 120(N+1) represents the additional endpoint 120 of the second event.

Endpoint 120(1) exists at location 352, and endpoint 120(N+1) exists at location 354. Endpoints 120(1) and 120(N+1) communicate with event management system using network connections 134(1) and 134(N+1), respectively. Prior to the second event, endpoint 120(1) provides a set of attendees 122(1) with a set of A/V media streams 124(1) of the first event. Upon creation of the second event, a subset 122(1)B of the set of attendees 122(1) moves to endpoint 120(N+1) at location 354 to participate in the second event. The endpoint 120(N+1) provides subset 122(1)B with a set of A/V media streams 124(N+1) of the second event. Location 352 is sufficiently near to location 354 to allow subset 122(1)B of the set of attendees 122(1) to move between endpoints 120(1) and 120(N+1) in a reasonable amount of time.

During the second event, endpoint 120(1) provides a remaining subset 122(1)A of the set of attendees 122(1) with the set of A/V media streams 124(1) of the first event. A/V media streams 124(1) may be the same prior to and subsequent to the second event being created (e.g., where the second event does not include any of endpoints 120(2)-120(N)), or A/V media streams 124(1) may be modified to exclude A/V media streams from one or more of endpoints 120(2)-120(N) that move to the second event. Changes to the A/V media streams 124(1) are made in accordance with registered event specifications 142, dynamic event context 144, event endpoint information and policies 146, and inputs from attendees 122(1)A and 122(1)B.

Locations 352 and 354 are situated with respect to one another so that the first and the second events do not substantially interfere with one another. More particularly, endpoints 120(1) and 120(N+1) are sufficiently separated from each other so that the sets of A/V media streams 124(1) and 124(N+1) do not substantially audibly or visually interfere with one another from the perspective of the attendees included in subsets 122(1)A and 122(1)B. Accordingly, the set of A/V media streams 124(1) do not substantially interfere with the reception of the set of A/V media streams 124(N+1) by subset 122(1)B, and the set of A/V media streams 124(N+1) do not substantially interfere with the reception of the set of A/V media streams 124(1) by subset 122(1)A. In addition, endpoint 120(N+1) is sufficiently separated from the remaining endpoints 120(2)-120(N) (not shown) of the first event so that the set of A/V media streams 124(N+1) does not substantially interfere with any of the sets of A/V media streams 124(2)-124(N) from the perspectives of the attendees included in subset 122(1)B and sets of attendees 124(2)-124(N). Because locations 352 and 354 are situated to prevent the first and the second events from substantially interfering with one another, attendees of the first event may collaborate separately from attendees of the second event without experiencing any disruptions caused by the second event. Likewise, attendees of the second event may collaborate separately from attendees of the first event without experiencing any disruptions caused by the first event.

Locations 352 and 354 may be situated with respect to one another to prevent substantial interference between the first and the second events in any suitable way. In the example of FIG. 5, a barrier 356 separates locations 352 and 354. Barrier 356 may be any suitable type and/or combination of a wall, a door, a corridor, or other suitable physical structure or space that separates locations 352 and 354.

In one embodiment, location 352 represent a conference room, location 354 represents a hallway or vestibule outside the conference room, and barrier 356 represents a door and/or wall that separates the conference room from the hallway or vestibule. In this embodiment, endpoint 120(1) is inside the conference room and endpoint 120(N+1) is in the hallway or vestibule outside of the conference room. Endpoint 120(1) may be a collaboration studio and endpoint 120(N+1) may be a touchpad, for example. In other embodiments, locations 352 and 354 represent other suitable structures for separating endpoints 120(1) and 120(N+1).

Although endpoints 120(1) and 120(N+1) provide the respective sets of A/V media streams 124(1) and 124(N+1) to respective subsets 122(1)A and 122(1)B of the set of attendees 122(1) in respective locations 352 and 354, some components of endpoints 120(1) and/or 120(N+1) may be located outside of respective locations 352 and/or 354 while preventing interference between the first and the second events.

Using the request to create the second event, event management system 110 creates an association between the first and the second events using the respective registered event specifications 142, dynamic event context 144, and event information and policies 146. Where the request originates from an endpoint 120 of the first event, event management system 110 may create the association by identifying the endpoint 120 as part of the first event. Where the request originates from another endpoint 120 or other suitable device, event management system 110 may create the association by identifying the attendee 122 that submitted the request as an attendee of the first event.

Referring back to FIG. 4, event management system 110 reconfigures the first event to continue without the attendees of the second event as indicated in a block 308. Event management system 110 updates registered event specifications 142 and/or dynamic event context 144 to indicate which attendees are present in the first and the second events. Where one or more endpoints 120 moves from the first event to the second event, event management system 110 causes the first event to be reconfigured to continue without the endpoint or endpoints 120 that moved during the second event. In particular, event management system 110 causes the media streams 124 of the first event not to include media streams 124 from the moved endpoint or endpoints 120. If no endpoints 120 moved or were otherwise changed in the first event, event management system 110 may simply update registered event specifications 142 and/or dynamic event context 144 to reflect the updated attendees in the first and the second events without altering the media streams 124 of the first event.

A determination is made be event management system 110 as to whether the second event ends as indicated in a block 310. Event management system 110 may determine the second event has ended in response to receiving a communication from an attendee of the second event or by detecting the states of endpoints 120 of the second event.

In response to the second event ending, event management system 110 may join at least part of the second event into the first event according to registered event specifications and/or dynamic event context as indicated in a block 312. When the second event ends, attendees of the second event may return to an endpoint 120 of the first event or cause one or more of the endpoints 120 of the second event to be joined or rejoined with the first event. For endpoints 120 that were not originally in the first event, event management system 110 may join the endpoints 120 into the first event by causing media streams from the first event to be provided to these additional endpoints 120. For endpoints 120 that moved from the first event to the second event, event management system 110 may rejoin the endpoints 120 into the first event by causing media streams from the first event to be provided to these endpoints 120. Event management system 110 may rejoin such endpoints to the first event in the same topology position without protracted request negotiation that may precede new endpoints joining the first event.

Examples of first and second events will now be shown and described with reference to FIGS. 6A-6C and FIGS. 7A-7C.

FIGS. 6A-6C is are block diagrams illustrating embodiments of first and second events 402 and 404. At a time t1, event 402 includes endpoints 120(1)-120(N) that provide respective A/V media streams 124(1)-124(N) to respective sets of attendees 122(1)-122(N) in respective locations 1-N. At a time t2 which is subsequent to time t1, event management system 110 creates event 404 in response to receiving a request from any of the attendees 122. In the example of FIG. 6A, event 404 includes endpoints 120(N+1)-120(N+2) that provide respective A/V media streams 124(N+1)-124(N+2) to a subset 122(1)B of the set of attendees 120(1) and a subset 122(2)B of the set of attendees 120(2) in respective locations N+1 and N+2. Subsets of attendees 122(1)B and 122(2)B collaborate in event 404 separately from event 402 using endpoints 120(N+1)-120(N+2).

In the example of FIG. 6A, none of endpoints 120(1)-120(N) are moved from event 402 to event 404. Accordingly, endpoints 120(1)-120(N) continue to provide respective NV media streams 124(1)-124(N). Endpoints 120(1) and 120(2), however, provide respective media streams 124(1) and 124(2) only to respective subsets of attendees 122(1)A and 122(2)A of respective sets of attendees 122(1) and 122(2). Event management system 110 updates registered event specifications 142 and or dynamic event context 144 to indicate which attendees are present in events 402 and 404.

At a time t3 which is subsequent to time t2, event management system 110 detects that event 404 has ended. In the example of FIG. 6B, subsets of attendees 122(1)B and 122(2)B return to locations 1 and 2, respectively, to rejoin event 402 using endpoints 120(1) and 120(2), respectively. Accordingly, event management system 110 updates registered event specifications 142 and/or dynamic event context 144 to indicate that subsets of attendees 122(1)A and 122(1)B are present at endpoint 120(1) and that subsets of attendees 122(2)A and 122(2)B are present at endpoint 120(2).

In another example shown in FIG. 6C, subset of attendees 122(2)B returns to location 2 to rejoin event 402 using 120(2) as described with reference to FIG. 6B. Subset of attendees 122(1)B, however, opts to join event 402 from location N+1 using endpoint 120(N+1). Event management system 110 joins endpoint 120(N+1) into event 402 and updates registered event specifications 142 and/or dynamic event context 144 to indicate that subset of attendees 122(1)B is present at endpoint 120(N+1) and that subsets of attendees 122(2)A and 122(2)B are present at endpoint 120(2).

FIGS. 7A-7C is are block diagrams illustrating embodiments of first and second events 412 and 414. At a time 11, event 412 includes endpoints 120(1)-120(N) that provide respective A/V media streams 124(1)-124(N) to respective sets of attendees 122(1)-122(N) in respective locations 1-N. Ate time t2 which is subsequent to time t1, event management system 110 creates event 414 in response to receiving a request from any of the attendees 122. In the example of FIG. 7A, event 414 includes endpoints 120(1) and 120(N+1) that provide respective A/V media streams 124(1) and 124(N+1) to the set of attendees 120(1) and a subset 122(2)B of the set of attendees 120(2) in respective locations 1 and N+1. Set of attendees 122(1) and subset of attendees 122(2)B collaborate in event 414 separately from event 412 using endpoints 120(1) and 120(N+1).

In the example of FIG. 7A, endpoint 120(1) is moved from event 412 to event 414. Accordingly, event management system 110 reconfigures event 412 to continue with endpoints 120(2)-120(N) which continue to provide respective A/V media streams 124(2)-124(N). Endpoint 120(2), however, provides media streams 124(2) only to subset of attendees 122(2)A of set of attendees 122(2). Event management system 110 updates registered event specifications 142 and/or dynamic event context 144 to indicate which attendees are present in events 412 and 414.

At a time t3 which is subsequent to time t2, event management system 110 detects that event 414 has ended. In the example of FIG. 7B, the set of attendees 122(1) opts to rejoin event 412 using endpoint 120(1) and the subset of attendees 122(2)B returns to location 2 to rejoin event 412 using endpoint 120(2). Event management system 110 rejoins endpoint 120(1) into event 412 and updates registered event specifications 142 and or dynamic event context 144 to indicate that the set of attendees 122(1) is present at endpoint 120(1) and that subsets of attendees 122(2)A and 122(2)B are present at endpoint 120(2).

In another example shown in FIG. 6C, the set of attendees 122(1) opts to rejoin event 412 using endpoint 120(1) and the subset of attendees 122(2)B opts to join event 412 using endpoint 120(N+1). Event management system 110 rejoins endpoint 120(1) into event 412, joins endpoint 120(N+1) into event 412, and updates registered event specifications 142 and/or dynamic event context 144 to indicate that the set of attendees 122(1) is present at endpoint 120(1) and that the subset of attendees 122(2)B is present at endpoint 120(N+1).

In the above embodiments, event management system 110 may include any suitable combination of hardware and software components. In one embodiment, event management system 110 includes one or more programs that is stored in any suitable type, number, and/or combination of portable or non-portable storage media (not shown) within or otherwise accessible to event management system 110. The programs are accessible to and executable by any suitable type, number, and/or combination of processors (not shown) in event management system 110 to perform the functions described above.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the optical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited by the claims and the equivalents thereof.

What is claimed is:

1. A method performed by an event management system, the method comprising:
hosting a first event that includes a first set of event endpoints that provides first and second sets of media streams to respective first and second sets of attendees during the first event; and
while hosting the first event, creating a second event that includes a it) second set of event endpoints that provide a third set of media streams to at least one of the first set of attendees and a fourth set of media streams during the second event;
wherein a first one of the second set of event endpoints is sufficiently separated from each of the first set of event endpoints so that the second event does not substantially interfere with the first event.

2. The method of claim 1 wherein a second one of the second set of event endpoints is sufficiently separated from each of the first set of event endpoints so that the second event does not substantially interfere with the first event.

3. The method of claim 1 further comprising:
creating the first event to include a second one of the second set of event endpoints prior to the second event being created; and
moving the second one of the second set of event endpoints to the second event subsequent to creating the second event.

4. The method of claim 3 further comprising:
rejoining the second one of the second set of event endpoints into the first event subsequent to the second event ending.

5. The method of claim 1 further comprising:
joining the first one of the second set of event endpoints into the first event subsequent to the second event ending.

6. The method of claim 1 wherein the first one of the second set of event endpoints is outside of a room that includes one of the first set of event endpoints.

7. The method of claim 1 further comprising:
creating the second event in response to a request from the one of the first set of attendees.

8. The method of claim 1 further comprising:
receiving a request to create the second event from one of the first set of event endpoints located near the first one of the second set of event endpoints.

9. The method of claim 1 further comprising:
receiving a request to create the second event from the first one of the second set of event endpoints.

10. The method of claim 1 wherein the second set of event endpoints that provide the third set of media streams to the at least one of the first set of attendees and the fourth set of media streams to at least one of the second set of attendees during the second event.

11. A system comprising:
a network interface configured to connect to a network; and
an event management system coupled to the network interface;
wherein the event management system is configured to cause first and second event endpoints to provide respective first and second sets of media streams to respective first and second sets of attendees during a first event using the network interface, wherein the event management system is configured to receive a request to create a second event that includes at least a third event endpoint that is sufficiently separated from each of the first and the second event endpoints so that the second event does not substantially interfere with the first event when providing a third set of media streams to a first subset of the first set of attendees, wherein the event management system is configured to provide an option to join the second event to at least the first and the second sets of attendees during the first event, and wherein the event management system is configured to maintain an association between the first event and the second event.

12. The system of claim 11 wherein the event management system is configured to cause the second event endpoint to join the second event.

13. The system of claim 12 wherein the event management system is configured to cause the second event endpoint to rejoin the first event using the association.

14. The system of claim 11 wherein the event management system is configured to cause a fourth event endpoint to join the second event.

15. The system of claim 11 wherein the event management system is configured to cause the fourth event endpoint to join the first event using the association in response to the second event ending.

16. A program product comprising:
a program executable by a processor for causing the processor to:
receive, during a first event that includes a first set of event endpoints providing first and second sets of media streams to respective first and second sets of attendees, a request to create a second event; and
during the first event, create the second event in response to receiving the request to include a second set of event endpoints that provide a third set of media streams to at least one of the first set of attendees and a fourth set of media streams to at least one of the second set of attendees during the second event, wherein a first one of the second set of event endpoints is sufficiently separated from each of the first set of event endpoints so that the second event does not substantially interfere with the first event;
a medium that stores the program so that the program is accessible by the processor.

17. The program product of claim 16 wherein the program is executable by the processor for causing the processor to:
receive the request from one of the first set of event endpoints.

18. The program product of claim 16 wherein the program is executable by the processor for causing the processor to:
receive the request from the first one of the second set of event endpoints.

19. The program product of claim 16 wherein the program is executable by the processor for causing the processor to:
reconfigure the first event to continue without at least one of the second set of event endpoints during the second event.

20. The program product of claim 16 wherein a second one of the second set of event endpoints is sufficiently separated from each of the first set of event endpoints so that the second event does not substantially interfere with the first event.
